(19) United States
(12) Patent Application Publication
(10) Pub. No.: US 2022/0019946 A1
(43) Pub. Date: Jan. 20, 2022

(54) SYSTEMS AND METHODS FOR GENERATING AND UPDATING TRAVEL ITINERARIES

(71) Applicant: UST Global Inc, Aliso Viejo, CA (US)

(72) Inventor: Arun Suresh Kumar, Trivandrum (IN)

(21) Appl. No.: 17/017,059

(22) Filed: Sep. 10, 2020

(30) Foreign Application Priority Data
Jul. 20, 2020 (IN) 202011030868

(51) Int. Cl. G06Q 10/02; H04L 12/58; G06Q 30/02; G06Q 10/04; G06N 3/08

(52) U.S. Cl. CPC G06Q 10/025; H04L 51/24; G06N 3/088; G06Q 10/047; G06Q 30/0282

(57) ABSTRACT

A system is configured to: determine an itinerary based on inputs received from a client device associated with a first user, user profiles associated with other users, and a user profile associated with the first user; generate a warning signal based on status signals received from the client device, the warning signal indicating at least one of a cancellation of a first event in the itinerary or a delay of the first event in the itinerary; determine an adjustment to be made to the itinerary based on the warning signal; provide the adjustment to the client device; receive a feedback signal from the client device, the feedback signal indicating that the adjustment be made to the itinerary; and adjust the itinerary according to the adjustment.

### PRIORITY CLAIM

This application claims priority to India Provisional Application No. 202011030868, filed Jul. 20, 2020, which is hereby incorporated by reference herein in its entirety.

### TECHNICAL FIELD

The present disclosure relates to generating travel itineraries and more specifically to systems and methods for generating travel itineraries that can be automatically updated in realtime.

### BACKGROUND

Travel is an integral part of human culture, and most individuals are not sedentary, staying at one location throughout the day. On a typical day, an individual may commute to work via a train, a car, a bicycle, or some other mode of transportation. When at work, the individual may take a lunch break and walk to a nearby restaurant. After work, the individual may enjoy a movie at the movie theatre of may attend an orchestra concert. The events described are local in nature, and as such, when performed and repeated multiple times, the individual, by habit, can readily determine a best time to leave for work, which mode of transportation to take to work, select the restaurant to go to for lunch and a best mode of transportation to the movie theatre or to the nearby restaurant.

Unfortunately, when an individual does not have a habit or is in a new environment or an unfamiliar territory, simple decisions like a best mode of transport or where to eat lunch can take long to decide. Furthermore, if the individual wants to determine a best way to spend her time, then time wasted in somewhat unimportant decisions can impact an overall happiness or satisfaction of the individual. Usually, when taking a trip or when traveling away from home, individuals do not have a habit associated with their destination location. As such, trips that should be seamless with reduced stress can turn stressful due to a lack of default options. The present disclosure provides systems and methods for generating travel itineraries at least to provide default options for individuals. Automatically generating travel itineraries provides several advantages as will be apparent in the description below.

### SUMMARY

According to some implementations of the present disclosure, a system for dynamically updating travel itineraries is provided. The system includes a processor and a non-transitory computer readable medium storing instructions such that when the instructions are executed by the processor, the system is configured to: (a) determine an itinerary based on inputs received from a client device associated with a first user, user profiles associated with other users, and a user profile associated with the first user, wherein the user profile associated with the first user includes prior travel habits of the first user and preferences of the first user; (b) generate a warning signal based on status signals received from the client device, the warning signal indicating at least one of a cancellation of a first event in the itinerary or a delay of the first event in the itinerary; (c) determine an adjustment to be made to the itinerary based on the warning signal, wherein the adjustment includes at least one of: (i) removing a second event from the itinerary, (ii) extending a duration of the second event, or (iii) swap the second event and a third event in the itinerary; (d) provide the adjustment to the client device; (e) receive a feedback signal from the client device, the feedback signal indicating that the adjustment be made to the itinerary; and (f) adjust the itinerary according to the adjustment.

According to some implementations of the present disclosure, a method for dynamically updating travel itineraries includes: (a) determining, by a server, an itinerary based on inputs received from a client device associated with a first user, user profiles associated with other users, and a user profile associated with the first user, wherein the user profile associated with the first user includes prior travel habits of the first user and preferences of the first user; (b) generating, by the server, a warning signal based on status signals received from the client device, the warning signal indicating at least one of a cancellation of a first event in the itinerary or a delay of the first event in the itinerary; (c) determining, by the server, an adjustment to be made to the itinerary based on the warning signal, wherein the adjustment includes at least one of: (i) removing a second event from the itinerary, (ii) extending a duration of the second event, or (iii) swap the second event and a third event in the itinerary; (d) providing, by the server, the adjustment to the client device; (e) receiving, by the server, a feedback signal from the client device, the feedback signal indicating that the adjustment be made to the itinerary; and (f) adjusting, by the server, the itinerary according to the adjustment.

According to some implementations of the present disclosure, a client device associated with a first user is provided. The client device includes a processor and a non-transitory computer readable medium storing instructions such that when the instructions are executed by the processor, the client device is configured to: (a) send inputs to a server; (b) receive, from the server, an itinerary based on the sent inputs, user profiles associated with other users, and a user profile associated with the first user, wherein the user profile associated with the first user includes prior travel habits of the first user and preferences of the first user; (c) send status signals to the server; (d) receive an adjustment from the server, the adjustment including at least one of: (i) removing a second event from the itinerary, (ii) extending a duration of the second event, or (iii) swap the second event and a third event in the itinerary, wherein the adjustment was generated based on the status signals indicating at least one of a cancellation of a first event in the itinerary or a delay of the first event in the itinerary; (e) send a feedback signal to the server, the feedback signal indicating that the adjustment be made to the itinerary; and (f) receive an adjusted itinerary from the server.

The foregoing and additional aspects and implementations of the present disclosure will be apparent to those of ordinary skill in the art in view of the detailed description of various embodiments and/or implementations, which is made with reference to the drawings, a brief description of which is provided next.

### BRIEF DESCRIPTION OF THE DRAWINGS

The foregoing and other advantages of the present disclosure will become apparent upon reading the following detailed description and upon reference to the drawings.

FIG. 1 illustrates a block diagram of a system for managing itineraries according to some implementations of the present disclosure;

FIG. 2 illustrates an example flow for making live changes to an itinerary in response to a delay, according to some implementations of the present disclosure;

FIG. 3 is a flow diagram showing steps for updating a travel itinerary according to some implementations of the present disclosure;

FIG. 4 is a screenshot of an itinerary according to some implementations of the present disclosure; and

FIG. 5 is a graph of foot traffic according to some implementations of the present disclosure.

While the present disclosure is susceptible to various modifications and alternative forms, specific implementations have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the present disclosure as defined by the appended claims.

### DETAILED DESCRIPTION

Even with the advancement of technology, travel planning remains to be a task involving a great amount of human effort. Most travel booking platforms or agencies provide hotel, flight, and activity bookings, but they fail to integrate all these books taking into consideration commute times from the involved points of interest. For example, a hotel chosen may be forty minutes away from the airport while activities are about ten minutes from the airport. A more preferred option would be to select a hotel that is closer to the activities since the activities and the airport are more centrally located than the hotel. Most travel book platforms also fail to take into consideration preferred points of interest from users. Some activities and locations are more popular than others and should be taken into account. A user may thus have preferences on where to stay, what to do during the stay, etc., and these should be taken into account. Most travel platforms offer an itinerary that remains static and unchangeable.

Some embodiments of the present disclosure provide an intelligent system that works along with an individual to aid in creating tailor-made itineraries according to the individual's preferences, effectively utilizing knowledge from previous trips. Some embodiments of the present disclosure further provide provisions for future modifications which is desirable for most individuals considering that plans and itineraries are merely guidelines and gross departures from itineraries are not an uncommon phenomenon. For example, a family with small children will likely not maintain strict time schedules while visiting attractions or performing activities. Therefore, itineraries should either be flexible with lax scheduling or should be amenable to changes.

Some embodiments of the present disclosure provide an artificial intelligence (AI) enabled travel planning and booking platform. The platform creates user-customized travel itineraries for individuals based on inputs from the individuals, data generated from previous travelers, and data generated by learning prior travel habits and preferences of the individuals. The platform can effectively schedule an individual's itinerary in such a way that the itinerary is optimized, taking into consideration commute time between points of interest, opening and closing hours of the points of interest, best times to visit particular points of interest, etc. The platform can book hotels, flights and activities with a single payment entry and submission. Itineraries generated according to some embodiment of the disclosure allow well-aligned bookings such that travel times from hotel, airport, etc., are minimized. Well-aligned bookings are bookings aligned to individual preferences such that the individual is less stressed and can alleviate mental decision making processing on which restaurants to visit, which activities to undertake, which hotel to stay at, etc. The platform can provide a tailor-made itinerary to the individual, and can dynamically update the itinerary in case of cancellations, delays or any other unexpected events. Some embodiments of the present disclosure consider popularity of destinations and seasonal or societal conditions surrounding events or destinations which may impact an individual's trip.

Some advantages of a travel system designed according to embodiments of the present disclosure are achieved using machine learning and various metrics. The metrics introduced allow quantification and consideration of variables that were previously diffuse or not being able to be considered. These variables increase confidence and accuracy of automatically updated itineraries, thus enabling networked systems to maintain itineraries without much human intervention once the itineraries are created, and activities and services are booked. Other travel itineraries may be adept at booking hotels and flights, but are insufficient when specific activities or attractions are of concern. While flights and hotels can easily be grouped into separate categories and alternatives between different flights or different hotels are apparent, activities and attractions are much harder to categorize or suggest alternatives to because activities and attractions are heavily dependent on individual proclivities. Suggesting horseback riding as a substitute for a coffee break is not the same as choosing a Lufthansa® airlines flight over a United Airlines® flight. Embodiments of the present disclosure solve this problem at least by grouping similar individuals, so that attractions and activities provided to a specific individual are relevant to that specific individual. Embodiments of the present disclosure develop a computational model that can be quickly searched by leveraging cluster techniques, thereby improving speed and possibly reducing amount of computer memory needed to realize individualized computational strategy for itineraries.

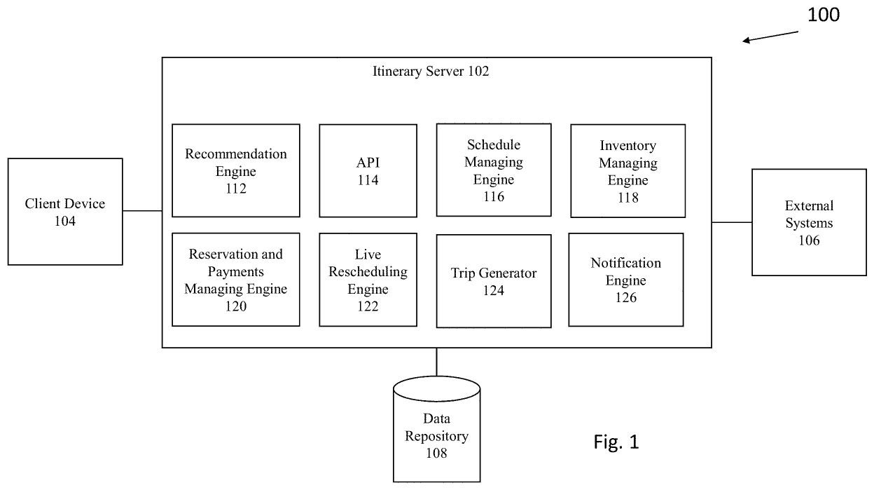

FIG. 1 illustrates a block diagram of a system 100 for managing itineraries according to some implementations of the present disclosure. To simplify discussion, the singular form will be used for components identified in FIG. 1 when appropriate, but the use of the singular does not limit the discussion to only one of each such component. The system 100 includes a client device 104, an itinerary server 102, a data repository 108, and an external system 106. Each of these components can be realized by one or more computer devices and/or networked computer devices. The computer devices include at least one processor with at least one non-transitory computer readable medium.

The client device 104 is any computing device that can provide commands to or that can communicate with the itinerary server 102 to request the itinerary server 102 perform various tasks such as generate an itinerary, solidify bookings, confirm changes in the itinerary, etc. The client device 104 can be a laptop computer, a desktop computer, a smartphone, a smart speaker, a smart television, a smart watch, a fitness tracker, etc. The client device 104 can have wired and/or wireless network connectivity to the itinerary server 102. The client device 104 and the itinerary server 102 can communicate using the Internet or cellular bands to facilitate accessing the itinerary server 102 from any place in the world. In some implementations, the client device 104 includes a global positioning system (GPS) receiver for communicating position information to the itinerary server 102.

The system 100 can use the data repository 108 for storage. The itinerary server 102 may need to store machine learning algorithm parameters, data collected from the external systems 106, data collected from the client device 104, intermediate and final calculations of various metrics when determining itineraries, etc. The data repository 108 can store settings, or other configuration utilized for maintaining itineraries. For example, the data repository 108 can store a user cluster index for an individual, a budget correlation index for that individual, sentiment scores for reviews obtained from the external systems 106, etc.

The system 100 includes the itinerary server 102 which can include a recommendation engine 112, an application programming interface (API) 114 for translating communication between the itinerary server 102 and the client device 104, a schedule managing engine 116, an inventory managing engine 118, a reservation and payments managing engine 120, a live rescheduling engine 122, a trip generator 124, and a notifications engine 126. An engine, generator, or manager is a combination of hardware and software configured to perform specific functionality as described herein. The hardware can be a processor, a microprocessor, a controller, a microcontroller, etc. The itinerary server 102 is configured to receive initial parameters from the client device 104 to generate an itinerary, alert the client device 104 of updates to the itinerary, and communicate with external systems 106 to secure bookings associated with the generated itinerary. For example, the client device 104 can provide the itinerary server 102 with an origin and a destination, and the itinerary server 102 can generate an itinerary that can include airline and flight information, hotel information, a schedule of activities during the trip, etc. In another example, the client device 104 can provide GPS signals that allow the itinerary server 102 to update the travel information in the itinerary to remove or reschedule activities based on a location provided by the GPS signals. In another example, the itinerary server 102 can conduct financial transactions with the external systems 106 to secure or cancel flight tickets, hotel tickets, activity tickets, etc. The itinerary server 102 uses the recommendation engine 112, the API 114, the schedule managing engine 116, the inventory managing engine 118, the reservation and payments managing engine 120, the live rescheduling engine 122, the trip generator 124, the notifications engine 126, or any combination thereof, to create and/or manage itineraries according to some embodiments of the present disclosure.

The recommendation engine 112 of the itinerary server 102 can perform one or more functions. These functions can be realized by using a neural network or a machine learning approach. The recommendation engine 112 is configured to suggest or provide an individual associated with the client device 104 with one or more destinations for a trip. The destinations recommended by the recommendation engine 112 can have an expiratory period, that is, the recommendation engine 112 can only guarantee or suggest these destinations for only a particular period. In an example, the recommendation engine 112 can suggest that the individual visit the destination during the summer months, during the winter months, during a specific week of the year, during a holiday period, during specific occurrences (e.g., a lunar eclipse, a solar eclipse, summer Olympic games, winter Olympic games, etc.). The recommendation engine 112 can perform the aforementioned one or more functions in order to generate and recommend particular destinations to the individual or user associated with the client device 104. These functions include generating user cluster indices, generating budget correlation indices, generating sentiment scores, and/or generating social and trend indices.

The recommendation engine 112 can generate a user cluster index value based on a gender of the individual, an age of the individual, past preferences of the individual, a geographical region where the individual is located, a geographical region where the individual will be located in the future, etc. The itinerary server 102 can maintain user profiles and associate each user of the system 100 to a specific user profile, such that user preferences can be stored and can be easily associated with each user of the system 100. The itinerary server 102 can perform data analysis on the information gathered from a plurality of users to assign user cluster index values to each user in the plurality of users.

In some implementations, a clustering technique like K-means clustering is used by the recommendation engine 112. The recommendation engine 112 uses the clustering technique to determine groupings in the plurality of users such that the users can be grouped based on gender, age, geographic region, or any combination thereof. Preferably, an unsupervised clustering technique that can automatically estimate an optimal number of clusters from user profile data is used. Example techniques that can be used include mean-shift clustering, density-based spatial clustering of applications with noise, expectation-maximization (EM) clustering using Gaussian mixture models, K-means clustering, etc. In order to apply an unsupervised clustering technique, user data for each user can be represented as a multi dimensional vector that can be represented in a multi-dimensional vector space. Within the vector space, the unsupervised clustering technique groups similar vectors together. Vectors grouped together are assigned a similar user cluster index. The user cluster index can be expressed as a label or can be expressed as an integer or a whole number.

Assigning similar user cluster indices allows the recommendation engine 112 to separate the total plurality of users into multiple segments such that preferences of each user segment can be learned, for better catering to each user segment. The separation of users into segments speeds up processing of large amount of data pertaining to each user. That is, each defined segment contains users that have similar properties, which will alleviate any computational load, thus conserving memory space, when performing calculations.

Furthermore, separating users into different user segments allows the recommendation engine 112 to provide more pertinent suggestions to a particular user. The recommendation engine 112 can provide the following information to the particular user: (a) 70% of individuals “like you” searched for Destination A for their next vacation; (b) Individuals who have similar food preferences like yours tried Restaurant B and the following special dishes; and (c) You may like to stay in Hotel C, as it is one of the tops picks by individuals “like you”. “Like you” in the suggestions can be replaced with a property that captures a description of the specific user cluster index. Example descriptions can be individuals between 30 and 40 who enjoy parasailing, individuals in a certain geographical region of a certain age group, individuals of a certain taste in food, etc. When suggesting travel destinations to the particular user, the recommendation engine 112 can provide a popup or alert on a smartphone of the user. For example, if the user is located in India, an example message provided to the user can state “A large number of people in India are currently using the platform to plan a trip to London right now Get in on the hype” Classifying users into segments or cohorts thus allows the itinerary server 102 to provide more relevant recommendations for particular users.

The recommendation engine 112 can also use other techniques to classify users according to interactions between users and the itinerary server 102. For example, a user associated with the client device 104 goes golfing, and the recommendation engine 112 determines that the client device 104 is at a golf club. The recommendation engine 112 can insert in the user's profile a preference for golf activities. In some embodiments, the user uses the client device 104 to perform a search on the itinerary server 102 on potential activities including visiting a beach or a museum, and the recommendation engine 112 can store these points of interests as preferences for types of places or activities that the user may prefer. The recommendation engine 112 can update a particular user's cluster index value after the user interacts with the itinerary server 102. That is, there is a possibility that a user's interaction can change the user's cluster index value. The update of the user index can occur on a schedule where at a certain time of day, the recommendation engine 112 runs an update task that considers changes in user profiles and determines cluster indices of all users. In some implementations, the update of the user cluster index can be incremental, where only users whose data has changed have their clusters updated to determine whether they now fall into a different cluster or not. In some implementations, the update of the user cluster index can end up creating a new cluster index if the recommendation engine 112 ends up grouping users in a different manner than were previously grouped. Using unsupervised learning for grouping users provides a dynamic way of reflecting any changes in user preferences or any changes in society or societal makeup, without human intervention. By clustering users according to some implementations of the present disclosure, the recommendation engine 112 will be able to provide better destination matches to particular users, thus providing a curated experience for the particular users.

Besides determining user cluster index, the recommendation engine 112 can provide another function when considering destinations, determining a budget correlation index for a particular user based on the particular user's past preferences and spending history. Preferences paired with spending history can indicate purchasing power parity between different locations. Past preferences can be identified either from user activity, including searches or interactions with the itinerary server 102, or can be identified based on verified past trips of the user. Past preferences help identify weightage cost to be considered while selecting hotels, restaurants, mode of transportation, etc. Budget correlation index can be used by the recommendation engine 112 to suggest hotels within a price range of a user. For example, budget correlation index can indicate purchasing power parity with respect to India and the United States of America (USA) as 1 US Dollar (USD) being equivalent to 18.381 Indian Rupee (INR). If a user from the USA previously booked a hotel for 100 USD per night under the budget category of economy, then the recommendation engine 112 can suggest hotel ranges from 1,838 INR as being under the budget category of economy when suggesting a destination in India. In another example, if a user from India previously booked a hotel for 2,000 INR per night under the budget category of economy, then the recommendation engine 112 can suggest hotel ranges from 108 USD as being in the range of an economy budget category. As such, instead of just straight conversion rates, user preferences also play into budget correlation indices to take into account purchasing power parities (e.g., equalizing economy budget ranges) between different destinations.

The recommendation engine 112 can provide another function when considering destinations, performing sentiment analysis from user and/or traveler feedback. Users can provide reviews on selected activities, hotels, airlines, car services, ferry services, etc. The user reviews and feedback can be stored in the data repository 108 and can be associated with user profiles. The user reviews and feedback can sometimes be obtained from external systems 106. For example, Yelp® reviews, Google® reviews, etc., can be obtained from the external systems 106 for particular activities, companies, attractions, etc. The reviews obtained from the external systems 106 can be linked to one or more users of the itinerary server 102. In some implementations, designated moderators can provide reviews. The recommendation engine 112 performs sentiment analysis on reviews and feedback, and the destination where the feedback or review pertains to can be classified with a sentiment score, which can be an index with a value between 0 and 1. Sentiment scores can be associated with a negative, neutral, or positive rating (e.g., the index can be −0.5, 0, or 0.5 to indicate a finite negative sentiment score, a neutral sentiment score, and a finite positive sentiment score, respectively). The recommendation engine 112 can use the sentiment score to suggest attractions or hotels to users within a same cluster group (i.e., a same user cluster index).

In some implementations, the recommendation engine 112 performs hybrid sentiment analysis based on a set of rules and some machine learning techniques to learn from generated data. In some implementations, in a first step, hybrid sentiment analysis involves the recommendation engine 112 tokenizing text in a user review. Tokenization involves splitting the user review into different parts. The different parts can be sectioned using delimiters like punctuation, words, and numbers. In a second step, hybrid sentiment analysis can involve speech tagging, where every word in the user review is tagged such that the tag annotates a role played by the word. For example, the tag can indicate the word as being a noun, an adjective, an adverb, a verb, etc. In a third step, hybrid sentiment analysis can involve word sense disambiguation for deducing meaning of every word in a same frame of reference. Word sense disambiguation involves determining synsets for the words. Synsets are a group of synonyms with examples of its operation and describe correlation among these synonym sets. In a fourth step, hybrid sentiment analysis can involve sentiment word net interpretation, where based on the derived synset, a score for each word can be searched for in a database of sentiment word nets. In a fifth step, hybrid sentiment analysis can involve sentiment orientation which refers to calculating positive and negative scores. Negative scores (s₋) and positive scores (s₊) can be combined to determine a sentiment score in the range of 0 to 1. For example, given s₋=σ(negative words) and s₊=σ(positive words), and S=s₊+s₋, then sentiment score can be expressed as:

$$Sentiment Score = \begin{matrix}\frac{( {s}_{+} - {s}_{-} )}{2 * S} & {s}_{+} \geq s - \\ \frac{( {s}_{-} - {s}_{+} )}{2 * S} & {s}_{+} < {s}_{-}\end{matrix} \qquad ( Eqn . 1 )$$

The recommendation engine 112 can provide another function when considering destinations, determining a social and trend index between the values of 0 and 1. The social and trend index provides a measure of a correlation between atmospheric conditions, emergency alerts, and social situations and trends of a destination. In an example, the social and trend index can be determined as a weighted average of emergency alerts (EA), social situations (SS), social trends (ST), and atmospheric conditions (AC) as expressed below:

$$Social \& Trend Index = \frac{( EA * {w}_{1} ) + ( SS * {w}_{2} ) + ( ST * {w}_{3} ) + ( AC * {w}_{4} )}{W} \qquad ( Eqn . 2 )$$

In Eqn. 2, W=w₁+w₂+w₃+w₄. In some implementations, the values of each of w₁, w₂, w₃, and w₄ is between 0 and 10. In some implementations, w₁>w₂>w₃>w₄. That is, w₁, w₂, w₃, and w₄ can be initialized with w₁>w₂>w₃>w₄, but in some implementations, after recursive learning by the recommendation engine 112, this relationship may not hold. The weights are calibrated based on user preferences and behavior. In Eqn. 2, social situations are based on multiple factors including financial crises, riots, etc. Social situation value is assigned based on polarities as given in the following. Social situation values can range from 0 to 1, i.e., social situation values are lower when factors like financial crises and riots exist and are higher when regional prosperity high in social, economical and all other areas. In some implementations, a count of a number of emergency alerts provided within a specific time period can be used in Eqn. 2. In some implementations, emergency alerts are normalized to a value between 0 and 1 where values closer to 1 indicate more emergency alerts than values closer to 0.

Social trends are based on multiple sets of values. For example, social trends can include the popularity and movements to a destination or other entities in the past and the predicted future based on the available data from the data warehouse and the inventory. For example, if a specific horseback riding spot was popular in the past, and the available data shows that the horseback riding spot has been gaining customers and visitors, then the social trend can indicate a higher value closer to 1 in the range of 0 and 1 for the specific horseback riding spot. A similar analogy can be extended to destinations where a popular destination that has been growing in popularity has a higher social trend value than one that is not growing in popularity. Atmospheric conditions in Eqn. 2 can also be coded with values ranging from 0 to 1. For example, inclement weather persisting in a location during a certain time of the year can push atmospheric conditions to be closer to 0 while sunny, breezy weather can push atmospheric conditions to be closer to 1. The recommendation engine 112 uses user cluster index, budget correlation index, sentiment score, and social and trend index to determine itinerary suggestions for a user.

The itinerary server 102 includes the API 114 that translates information between the client device 104 and the itinerary server 102. The API 114 allows different environments to communicate with one another through translation and encapsulation, e.g., via JSON. The API 114 can receive inputs like number of travelers from the client device 104 which allows the recommendation engine 112 to further customize the itinerary to be generated for the user. Number of travelers can be weighted highly or considered more closely during the reservation process to determine room availability at hotels, entry tickets for attractions and other activities, tickets for transit, etc. Time availability for each attraction or accommodation or restaurant and availability of tickets can be weighted highly compared to “best time to visit” and “open hours” when reserving these items. The API 114 can support live and interactive communication, thus enabling users to view itinerary changes based on different combinations or iterations of user inputs. Users can thus guide the itinerary server 102 via the API 114 in creating tailor-made itineraries that meet their preferences.

The API 114 can serve to facilitate receiving of other inputs from the client device 104. For example, a user can provide a budget plan which allows the recommendation engine 112 to determine whether the user wishes to have an upcoming trip under a certain budget category. For example, budget categories in order of increasing cost can include economy, premium, or business. The API 114 can facilitate receiving age of passengers from the client device 104. Age of passengers can help the recommendation engine 112 determine tickets that the reservation manager (i.e., the reservation and payments managing engine 120) should block. Age of passengers also allows the recommendation engine 112 to determine which entities or activities that particular user cluster or segments should avoid in a trip. The API 114 can facilitate receiving cuisine or type of food of interest. The cuisine type can inform on which category of restaurants to schedule for the user or group of users. The API 114 can also facilitate receiving what kind of trip is being expected by the user or group of users. The kind of trip can be informative on whether the user is planning for adventure, a visit to a historical site or place, or for some other category.

The itinerary server 102 includes a schedule managing engine 116 for deriving tailor-made custom itineraries. The schedule managing engine 116 can perform various functions including schedule control, activity selection, route optimization, cost optimization, and learning. Schedule control involves selecting which activity to place in the itinerary based on multiple factors. Schedule control can use a recurring neural network that utilizes inputs from a user's travel history. Some example inputs include a time for dining, relaxation, sleep, etc. Results from schedule control directly feed into activity selection in order to predict activity or activities to be considered for a current time and/or a remaining time available to the user. The schedule managing engine 116 can collect data from the client device 104 to predict activities. The data collected can be calendar events from personal mobile phone devices, location information of the personal mobile phone devices, inactivity of the personal mobile phone devices, movement of the personal mobile phone devices, etc. Actigraphy algorithms and walk detection algorithms can be used to identify user states (i.e., whether a user is on the move, whether the user is sedentary, etc.).

The schedule managing engine 116 can perform activity selection. Activity selection can involve multiple processes including selection of attractions, restaurants, hotels, etc. The schedule managing engine 116 uses constraint programming techniques to determine which activities to select. For example, in attraction selection, the schedule managing engine 116 takes into account factors including review for an attraction, how reachable is the attraction (e.g., distance and duration, availability of transport, etc.), popular times of the attraction, ticket availability for the attraction, and typical spend times at the attraction. Attraction selection can depend on user preferences, and attractions to select from can be ranked based on at least one of best time to visit, availability of tickets (if required), or crowd density. An attraction selection score can be computed for each attraction according to a weighted average formula as expressed in the following:

Attraction Selection Score=[(Best time to visit*w₁)+(Reachability*w₂)+(Minimum spend time*w₃)]/W (Eqn. 3)

In Eqn. 3, W=w₁+w₂+w₃ and in some implementations, the values of each of the weights w₁, w₂, and w₃ is between 0 and 10. Furthermore, w₁>w₂>w₃. The weight values in Eqn. 3 are unrelated to those expressed above in Eqn. 2. The variable names w₁, w₂, and w₃ are merely reused here with no connection to any previous use of w₁, w₂, and w₃. Also, just as in Eqn. 2, the initial relationship between the different weights may not hold after learning.

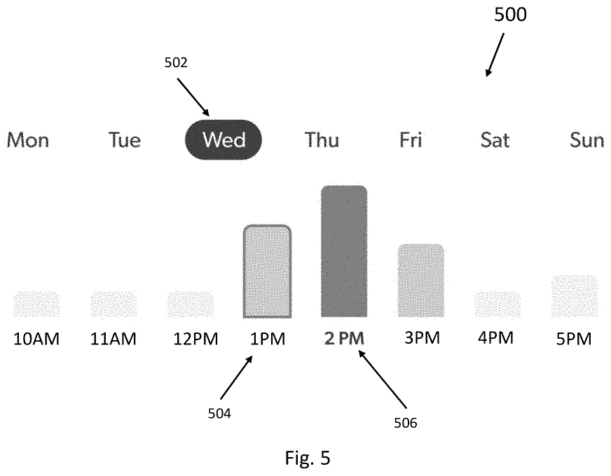

Best time to visit can be determined based on information obtained from the external systems 106. For example, the external systems 106 can include review systems that not only provide a rating for an attraction but provides an indication of foot traffic for the attraction and opening and closing times for the attraction. For example, foot traffic can be provided as a graph 500 by the external system 106 (as further discussed below in connection with FIG. 5). The schedule managing engine 116 can avoid selecting a most popular time, day, or period to visit in order to avoid lines or congestion that may be created due to movement of tourists, scheduling of festivals and other events. Best time to visit can be indicated in Eqn. 3 as a value between 0 and 1. With 1 indicating that the attraction is least congested and 0 indicating that the attraction is most congested.

Reachability is an indication of ease of transporting the user or group of users to the attraction and can take on a value between 0 and 1 (with 1 indicating most ease and 0 indicating lack of transportation). In some implementations, a multivariate rule of thumb is used where duration to the attraction, distance to the attraction, and number of available modes of transportation each comprise about thirty-three percent of Reachability, so that a trip to an attraction that is supposed to be under 30 minutes covering 2 miles with the option of going by car, bike, train, etc., can have Reachability of 1 while one that takes over 30 minutes covering 25 miles and has only the option of a car can have Reachability of 0.3.

In some implementations, Minimum spend time in Eqn. 3 is a normalized value between 0 and 1 where longer required spend times are closer to the value 1 and shorter spend times are closer to the value 0. For example, spending at least an hour at an attraction can be attributed to the value 1 and anything below an hour can take on a value less than 1 in a linearly declining manner. In some implementations, 10 minutes takes on the value 0 such that the values from 0 to 1 are linearly proportional to a slope between 10 minutes and 60 minutes (1 hour). 10 minutes and 1 hour are used here as examples, but in some implementations other limits can be used. Linear relationship is also used as an example, and in some implementations, other functions like logarithmic or power functions can be used.

In some implementations, the value for Minimum spend time is determined based on a remaining time to fill in an itinerary. Every attraction, restaurant and other activity will have a minimum spend time duration. For example, currently a traveler is at Location A, and while selecting the next attraction, restaurant, or activity, the schedule managing engine 116 determines whether Location B, Location C, Location D, Location E, or Location F is appropriate. Minimum time rank can be distributed in a manner such that minimum time is higher to the most feasible location out of Location B, Location C, Location D, Location E, and Location F. Minimum time for the least feasible location can be made lower. For example, two hours are left to complete the itinerary, and Location B requires three hours, Location C requires four hours, Location D and Location E each require two and a half hours, and Location F requires one hour. The scheduling managing engine 116 can set the value of Minimum spend time for Location F to be 1 and the value for Minimum spend time for location B to be 0, and the other locations can take on a value between 1 and 0. A liner relationship, power function, or any other function can be used in assigning the values between 1 and 0 for the other locations.

In restaurant selection, the schedule managing engine 116 considers multiple factors including, for example, budget correlation index (price level of the restaurant), reachability (distance and duration, availability of transport, etc.), reviews, available cuisines, opening and closing hours, etc. Restaurant selection can be picked based on a combination of user cluster index, input preferences obtained from the user, and top items or activities to try while at a specific destination. Restaurant selection use budget correlation index and heavily weight past preferences as suggested in the following restaurant selection score:

Restaurant Selection Score=[(Input preferences*w₁)+(Budget correlation index*w₂)+(Distance from attraction*w₃)+(Past preferences*w₄)+(User cluster index*w₅)]/W (Eqn. 4)

In Eqn. 4, W=w₁+w₂+w₃+w₄+w₅ and in some implementations, the values of each of w₁, w₂, w₃, w₄, and w₅ is between 0 and 10. Furthermore w₁>w₂>w₃>w₄>w₅. The weight values in Eqn. 4 are unrelated to those expressed above in connection to Eqns. 2 or 3. The variable names w₁, w₂, w₃, and w₄ are merely reused here with no connection to any previous use of w₁, w₂, w₃, and w₄.

Budget correlation index and User cluster index are budget correlation index and user cluster index, respectively, as previously discussed in connection with the recommendation engine 112 of FIG. 1. In some implementations, these two values can be normalized between the values of 0 and 1 for use in Eqn. 4. Different methods of normalization have been previously discussed above and are not repeated here. Distance from attraction is one factor discussed above in connection with reachability and can be normalized between the values of 0 to 1. For example, any distance under one mile is normalized to 0 and any distance above thirty miles is normalized to 1, and distances between one mile and thirty miles take on values between 0 and 1.

Input preferences is a coding of user preferences and can be stored in user profiles. Input preferences can take on a value between 0 and 1 and can be an indication of a type of cuisine (e.g., Indian cuisine, Japanese cuisine, Thai cuisine, etc.), a type of food category (e.g., pizza, fast food, healthy food, etc.), a type of dietary category (e.g., gluten-free, paleo, vegetarian, vegan, etc.), or any combination thereof. In an example, when a value for Input preferences, type of cuisine and type of dietary category are taken into account, and each of these will make up fifty percent of the value of Input preferences. The user can have the following preferences: Italian cuisine over Japanese cuisine over Thai cuisine, and a strong preference for gluten-free options. As such, when Restaurant A is being considered, Restaurant A can have Japanese cuisine but very limited gluten-free options. As such, Input preferences can be 0.4 with 0.3/0.5 being that Restaurant A has Japanese cuisine and 0.1/0.5 indicating that Restaurant A does not have much gluten-free options. In general, Input preferences can be calculated based on the formula (Number of available User Preferences) divided by (Total Number of User Preferences). That is, for a given restaurant, if the user has preferences (A, B, C, D), if the restaurant meets all of A, B, C, and D, then the value for Input preferences for the restaurant will be closer to or equal to 1. If the restaurant does not meet any of the preferences, then the value for Input preferences for the restaurant will be closer to or equal to 0.

Past preferences are data collected from the system 100 from the user during previous trips or during the user's interaction with the system through searching, etc. Past preferences can be treated in a similar manner as Input preferences (i.e., coded as a value between 0 and 1 and comprising different types or categories), and the discussion is not repeated herein.

In hotel selection, the schedule managing engine 116 can consider user reviews, room availability, etc. The schedule managing engine 116 can pick hotels based on user cluster index and user preferences with respect to budget correlation index in order to minimize travel costs. Past preference can have a most important rating in some embodiments when determining a hotel selection score.

Hotel Selection Score=[(Input preferences*w₁)+(Budget correlation index*w₂)+(Past preferences*w₃)+(User cluster index*w₄)]/W (Eqn. 5)

In Eqn. 5, W=w₁+w₂+w₃+w₄ and in some implementations, the values of each of w₁, w₂, w₃, and w₄ is between 0 and 10. Furthermore w₁>w₂>w₃>w₄. The weight values in Eqn. 5 are unrelated to those expressed above in connection to Eqns. 2, 3 or 4. The variable names w₁, w₂, w₃, and w₄ are merely reused here with no connection to any previous use of w₁, w₂, w₃, and w₄.

Input preferences and Past preferences can be coded as discussed above with respect to Eqn. 4. The difference with Eqn. 5 is that Eqn. 4 deals with restaurants while Eqn. 5 deals with hotels. Preferences can be types of hotels (e.g., one-star hotel, four star hotel, etc.), amenities within the hotel (e.g., swimming pool, fitness club, etc.), historical status of the hotel, hotel family (e.g., Marriott® hotel family vs. Hilton® hotel family), and so on. Coding of Input preferences and Past preferences can be between 0 and 1 as discussed above in connection with Eqn. 4 and is not repeated herein.

Route optimization performed by the schedule managing engine 116 includes traffic routing using recurring neural networks based on parameters from past traffic information from the data warehouse. The schedule managing engine 116 calculates the best route from the possible routes in-between two locations with relative travel mode. Route optimization is performed while planning the trip. Route optimization allows optimizing the itinerary with forecasted data from the data warehouse and from the inventory. Three factors can contribute to determining an optimized route, which includes distance, duration considering traffic (forecasted data used when planning and live data when on the trip), and surge pricing with respect to various forms of transit. In some implementations, scores can be calculated to determine an optimized route. A driving route score, a flight route score, and a walking route score can be determined. For example, driving route score can be calculated as a weighted average (e.g., Eqn. 6), flight route score can also be calculated as a weighted average (e.g., Eqn. 7), and walking route score can be calculated as a minimum function (e.g., Eqn. 8).

Driving Route Score=[(Distance*w₁)+(Duration considering traffic*w₂)+(Surge pricing*w₃)]/W (Eqn. 6)
where W=w₁+w₂+w₃ and w₁>w₂>w₃ and 10≥w₁, w₂, w₃≥0

The weight values in Eqn. 6 are unrelated to any of those expressed any equation above. The variable names w₁, w₂, and w₃ are merely reused here with no connection to any previous use of w₁, w₂, and w₃. Each of Distance, Duration considering traffic, and Surge pricing can be normalized to a value between 0 and 1.

Flight Route Score=[(Total duration*w₁)+(Layover duration*w₂)+(Surge pricing*w₃)+(Transit visa*w₄)]/W (Eqn. 7)
where W=w₁+w₂+w₃+w₄ and w₁>w₂>w₃>w₄ and 10≥w₁, w₂, w₃, w₄≥0

Walking Route Score=min(Distance) (Eqn. 8)

The weight values in Eqn. 7 are unrelated to any of those expressed any equation above. The variable names w₁, w₂, w₃, and w₄ are merely reused here with no connection to any previous use of w₁, w₂, w₃, and w₄. Total duration, Layover duration, Surge pricing, and Transit visa can be normalized to a value between 0 and 1. Total duration is an indication of how long the flight(s) take, Layover duration is an indication of how long layovers take for the flight(s), and Transit visa can be calculated as the number of transit visas required divided by a total number of flight legs.

Cost optimization is performed by the schedule managing engine 116 based on user cluster index and budget correlation index using a decision tree technique. Cost optimization can involve three actions, namely, travel cost optimizing, accommodation cost optimizing, and activity cost optimizing. Travel cost optimizing involves selecting flight and airport and/or local transit. When selecting flight and airport, the schedule managing engine 116 can divide each sector of a flight itinerary into different legs to build a cost-optimized itinerary by combining multiple smaller legs, thus guaranteeing the user will be able to make a connection time considering traffic density in airports. When selecting local transit, the schedule managing engine 116 can determine multiple factors like surge price based on the availability of cabs in order to optimize selection of transit modes. Overall, travel cost optimization can be determined based on a weighted average of budget correlation index, past preferences, and user cluster index.

The schedule managing engine 116 can also perform accommodation cost optimization based on budget preference index and user preference. The schedule managing engine 116 when performing accommodation cost optimization opts to determine a room combination that optimizes cost for a specific user. Similarly, restaurant cost optimization can be based on factors such as pricing level according to budget correlation index and user cluster index. Activity cost optimization can involve using crowd density values at an attraction or from the past and current inventory to determine whether to opt for premium or normal tickets. For example, if the schedule managing engine 116 forecasts a crowd is higher on an attraction and the available time allocated to spend over the attraction is low, the scheduling manager 116 will opt for a premium ticket, otherwise, it will opt for a normal ticket. Each of the accommodation cost optimization, restaurant cost optimization, and activity cost optimization can be determined using weighted averages of several variables as indicated below.

In an example, expressions that the schedule managing engine 116 uses in travel cost optimization, accommodation cost optimization, restaurant cost optimization, and attraction and/or activity cost optimization can be different based on a value of budget correlation index. When budget correlation index is between 0 and 0.5, the expressions for travel cost optimization can be expressed as:

[(Budget correlation index*w₁)+(Past preferences*w₂)+(User cluster index*w₃)]/W (Eqn. 9a)
where W=w₁+w₂+w₃ and w₁>w₂>w₃ and 10≥w₁, w₂, w₃≥0

The weight values in Eqn. 9a are unrelated to any of those expressed any equation above. The variable names w₁, w₂, and w₃, are merely reused here with no connection to any previous use of w₁, w₂, and w₃. Past preferences is similar to that described above in connection to, e.g., Eqn. 5. Past preferences can code data collected from a user's previous trips and from the user's searching pattern. For example, a traveler who always books hotels provided by Marriott® and has search results leaning towards Marriott will be indicated as having a preference for Marriot properties. A traveler who frequently fly in Emirates® will prefer flying in Emirates® in the future. When budget correlation index is between 0 and 0.5, the expressions for accommodation cost optimization can be expressed as:

[(Input preferences*w₁)+(Budget correlation index*w₂)+(Past preferences*w₃)+(User cluster index*w₄)]/W (Eqn. 9b)
where W=w₁+w₂+w₃+w₄ and w₁>w₂>w₃>w₄ and 10≥w₁, w₂, w₃, w₄≥0

The weight values in Eqn. 9b are unrelated to any of those expressed any equation above. The variable names w₁, w₂, w₃, and w₄ are merely reused here with no connection to any previous use of w₁, w₂, w₃, and w₄. When budget correlation index is between 0 and 0.5, the expressions for restaurant cost optimization can be expressed as:

[(Input preferneces*w₁)+(Budget correlation index*w₂)+(Past preferences*w₃)+(User cluster index*w₄)]/W (Eqn. 9c)
where W=w₁+w₂+w₃+w₄ and w₁>w₂>w₃>w₄ and 10≥w₁, w₂, w₃, w₄≥0

The weight values in Eqn. 9c are unrelated to any of those expressed any equation above. The variable names w₁, w₂, w₃, and w₄ are merely reused here with no connection to any previous use of w₁, w₂, w₃, and w₄. When budget correlation index is between 0 and 0.5, the expressions for attraction/activity cost optimization can be expressed as:

[(Budget correlation index*w₁)+(Crowd density*w₂)+(User cluster index*w₃)]/W (Eqn. 9d)
where W=w₁+w₂+w₃ and w₁>w₂>w₃ and 10≥w₁, w₂, w₃≥0

The weight values in Eqn. 9d are unrelated to any of those expressed any equation above. The variable names w₁, w₂, and w₃, are merely reused here with no connection to any previous use of w₁, w₂, and w₃. When budget correlation index is between 0.5 (inclusive) and 0.8, the expressions for travel cost optimization can be expressed as:

[(Past preferences*w₁)+(Budget correlation index*w₂)+(User cluster index*w₃)]/W (Eqn. 10a)
where W=w₁+w₂+w₃ and w₁>w₂>w₃ and 10≥w₁, w₂, w₃≥0

The weight values in Eqn. 10a are unrelated to any of those expressed any equation above. The variable names w₁, w₂, and w₃, are merely reused here with no connection to any previous use of w₁, w₂, and w₃. When budget correlation index is between 0.5 (inclusive) and 0.8, the expressions for accommodation cost optimization can be expressed as:

[(Input preferences*w₁)+(Past preferences*w₂)+(Budget correlation index*w₃)+(User cluster index*w₄)]/W (Eqn. 10b)
where W=w₁+w₂+w₃+w₄ and w₁>w₂>w₃>w₄ and 10≥w₁, w₂, w₃, w₄≥0

The weight values in Eqn. 10b are unrelated to any of those expressed any equation above. The variable names w₁, w₂, w₃, and w₄ are merely reused here with no connection to any previous use of w₁, w₂, w₃, and N. When budget correlation index is between 0.5 (inclusive) and 0.8, the expressions for restaurant cost optimization can be expressed as:

[(Input preferences*w₁)+(Past preferences*w₂)+(Budget correlation index*w₃)+(User cluster index*w₄)]/W (Eqn. 10c)
where W=w₁+w₂+w₃+w₄ and w₁>w₂>w₃>w₄ and 10≥w₁, w₂, w₃, w₄≥0

The weight values in Eqn. 10c are unrelated to any of those expressed any equation above. The variable names w₁, w₂, w₃, and w₄ are merely reused here with no connection to any previous use of w₁, w₂, w₃, and w₄. When budget correlation index is between 0.5 (inclusive) and 0.8, the expressions for attraction/activity cost optimization can be expressed as:

[(Crowd density*w₁)+(User cluster index*w₂)+(Budget correlation index*w₃)]/W (Eqn. 10d)
where W=w₁+w₂+w₃ and w₁>w₂>w₃ and 10≥w₁, w₂, w₃≥0

The weight values in Eqn. 10d are unrelated to any of those expressed any equation above. The variable names w₁, w₂, and w₃, are merely reused here with no connection to any previous use of w₁, w₂, and w₃. Crowd density can be normalized to a value between 0 and 1 in a similar manner as described in connection with other variables previously discussed. When budget correlation index is between 0.8 (inclusive) and 1 (inclusive), the expressions for travel cost optimization can be expressed as:

[(Past preferences*w₁)+(User cluster index*w₂)+(Budget correlation index*w₃)]/W (Eqn. 11a)
where W=w₁+w₂+w₃ and w₁>w₂>w₃ and 10≥w₁, w₂, w₃≥0

The weight values in Eqn. 11a are unrelated to any of those expressed any equation above. The variable names w₁, w₂, and w₃, are merely reused here with no connection to any previous use of w₁, w₂, and w₃. When budget correlation index is between 0.8 (inclusive) and 1 (inclusive), the expressions for accommodation cost optimization can be expressed as:

[(Input preferences*w₁)+(Past preferences*w₂)+(User cluster index*w₃)+(Budget correlation index*w₄)]/W (Eqn. 11b)
where W=w₁+w₂+w₃+w₄ and w₁>w₂>w₃>w₄ and 10≥w₁, w₂, w₃, w₄≥0

The weight values in Eqn. 11b are unrelated to any of those expressed any equation above. The variable names w₁, w₂, w₃, and w₄ are merely reused here with no connection to any previous use of w₁, w₂, w₃, and w₄. When budget correlation index is between 0.8 (inclusive) and 1 (inclusive), the expressions for restaurant cost optimization can be expressed as:

[(Input preferences*w₁)+(Past preferences*w₂)+(User cluster index*w₃)+(Budget correlation index*w₄)]/W (Eqn. 11c)
where W=w₁+w₂+w₃+w₄ and w₁>w₂>w₃>w₄ and 10≥w₁, w₂, w₃, w₄≥0

The weight values in Eqn. 11c are unrelated to any of those expressed any equation above. The variable names w₁, w₂, w₃, and w₄ are merely reused here with no connection to any previous use of w₁, w₂, w₃, and w₄. When budget correlation index is between 0.8 (inclusive) and 1 (inclusive), the expressions for attraction/activity cost optimization can be expressed as:

[(Crowd density*w₁)+(User cluster index*w₂)+(Budget correlation index*w3)]/W (Eqn. 11d)
where W=w₁+w₂+w₃ and w₁>w₂>w₃ and 10≥w₁, w₂, w₃≥0

The weight values in Eqn. 11d are unrelated to any of those expressed any equation above. The variable names w₁, w₂, and w₃, are merely reused here with no connection to any previous use of w₁, w₂, and w₃.

The schedule managing engine 116 also performs the function of learning, which involves re-indexing user cluster indexes, as discussed above in connection with the recommendation engine 112, and performing optimizations relating to schedule control. When learning, the schedule managing engine 116 collects and processes user data, which can include budget preference and interests, processes the data to gain insight, and updates indices accordingly. Indices updated can include the user cluster index, budget cluster index, and all weight ratios such that decisions made on cost, activity, routes, etc., are optimized. Insights help in weight calculation. For example, weight multiplier of “Budget correlation index” and “Hotel selection score” can be changed to a higher or lower priority according to insights learned from system data.

The itinerary server 102 can include the inventory managing engine 118. The inventory managing engine 118 can include an online marketplace in which multiple providers of accommodation, flights, activities, local cabs, and restaurants are available. The inventory of these items can be synchronized in realtime with suppliers and providers. The inventory managing engine 118 works with the external systems 106 to obtain this information from suppliers and provider systems (which are part of the external systems 106).

The itinerary server 102 can include the reservation and payments managing engine 120. The reservation and payments managing engine 120 interacts with the inventory managing engine 118 for bookings, cancellations, and modifications in the marketplace. Once a user is ready to proceed with a trip, the schedule managing engine 116 will issue (and/or modify) tickets after successful payments. The reservation and payments managing engine 120 is responsible for processing refunds by interacting with the inventory managing engine 118.

The itinerary server 102 can include the live rescheduling engine 122. Generated itineraries sometimes need to be modified and updated. Reasons for modification can include change in user preferences, cancellation of travel or accommodation service providers, unexpected delay while in transit or any emergencies as reported by the notification engine 126. The live rescheduling engine 122 considers delays, cancellations, and other unexpected events and passes the information to the schedule managing engine 116 such that modifications be made in the generated itinerary. The live rescheduling engine 122 allows the itinerary server 102 to account for any delays or unforeseen cancellations while the user is on the trip suggested by the itinerary such that the itinerary can be adapted to minimize effects of these changes thus minimizing difficulties faced by the user. The live rescheduling engine 122 enables realtime adjustment of the generated itinerary by the schedule managing engine 116.

Types of modifications that can be made can include route modification by the schedule managing engine 116 in the face of unexpected scenarios. Modifications can also include plan shifting which is also accomplished automatically under unforeseen or unexpected scenarios. The reservation and payments managing engine 120 may cancel tickets and/or book additional tickets according to a new plan. For example, tickets to an amusement park may be canceled in lieu of tickets to go see a play based on the user not being able to make it to the amusement park prior to the park closing.

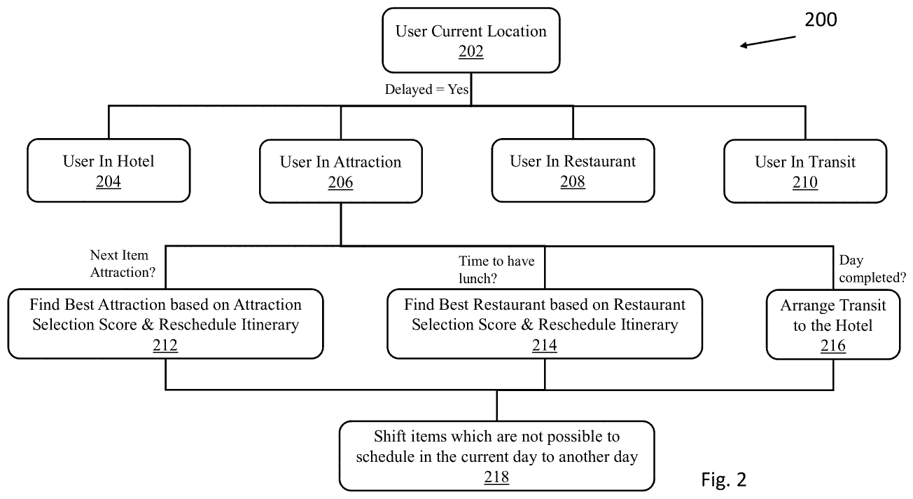

Referring to FIG. 2, example process 200 for how a delay can inform changes in a generated itinerary is provided. At step 202, the user's current location is monitored by the live rescheduling engine 122 (e.g., via a location of the client device 104). If the user is delayed, then the live rescheduling engine 122 determines a location for the user. For example, the user can be in a hotel 204, the user can be at an attraction 206, the user can be in a restaurant 208, the user can be on a local transit 210.

In the example of FIG. 2, if the user is at an attraction 206, then the live rescheduling engine 122 checks whether to move on to a next item attraction, whether to have lunch, or whether to arrange transit to the hotel. If moving on to the next item attraction, the live rescheduling engine 122 finds a next attraction based on attraction selection score and reschedules the itinerary at step 212. If time to have lunch, the live rescheduling engine 122 finds a restaurant based on restaurant selection score and reschedules the itinerary at step 214. If day is completed, then the live rescheduling engine 122 arranges transit to the hotel at step 216. At step 218, the live rescheduling engine 122 informs the schedule managing engine 116 to shift items which are not possible to schedule in the current day to another day at step 218. In some implementations, the reservation that cannot be rescheduled is canceled.

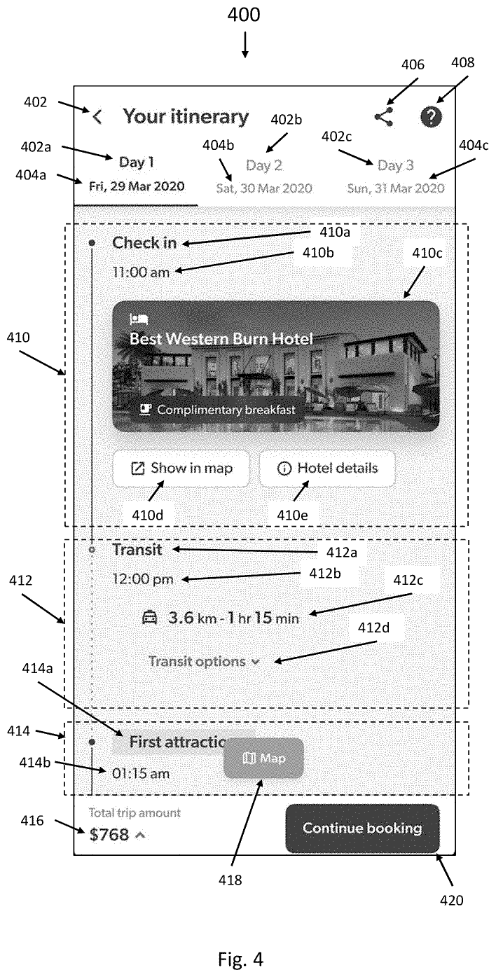

Referring back to FIG. 1, the itinerary server 102 can include the trip generator 124. The trip generator 124 generates itineraries based on outputs from the schedule managing engine 116 and transforms them into digital and non-digital forms for presenting to the user. Examples of non-digital forms include printed documents while digital forms can be displayed on the screen of the client device 104 (e.g., screenshot as shown in FIG. 4).

The itinerary server 102 can include the notification engine 126. The notification engine 126 generates alerts and notification. Alerts and notifications can be informational (e.g., trip time notifications) or can be warnings (e.g., extreme temperature alerts). Informational notifications or warning notifications can be trigged automatically based on trip-related events and delivered to users by means such as application and/or web notifications, SMS, emails, etc. Users can receive these notifications via the client device 104.

The notification engine 126 can be privy to information related to unexpected or undesirable situations that can impact an individual's trip. Some notifications can be deemed to be in an emergency category. These may include natural calamities, disease outbreaks, booking cancellations by service providers, etc. The notification engine 126 when dealing with emergency situations can trigger the live rescheduling engine 122 to rework or to modify a generated itinerary to account for the detected emergency.

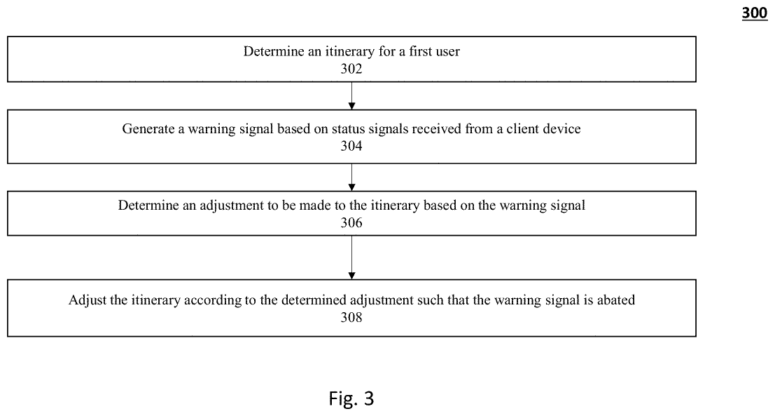

FIG. 3 is a flow diagram 300 showing steps for updating travel itineraries according to some implementations of the present disclosure. The steps in FIG. 3 can be implemented by the itinerary server 102. At step 302, the itinerary server 102 determines an itinerary for a first user. The itinerary can be determined based on inputs received from the client device 104. The client device 104 can be associated with the first user. The itinerary can also be determined based on user profiles associated with other users and a user profile associated with the first user. The user profile associated with the first user includes prior travel habits of the first user, preferences of the first user, positive user reviews provided as feedback by the first user, negative user reviews provided as feedback by the first user, a number of individuals that the first user usually travels with, hobbies of the first user, etc.

At step 304, the itinerary server 102 generates a warning signal based on status signals received from the client device 104. The warning signal can indicate at least one of a cancellation of a first event in the itinerary or a delay of the first event in the itinerary. For example, status signals received from the client device 104 can include GPS signals that provide a proxy for a location of the first user. In some implementations, the warning signals can be based on emergencies, for example, bad or inclement weather, unrest, a supplier or provider canceling tickets, etc. The itinerary server 102 generates the warning signal to indicate that a change should be made in the itinerary to maintain a schedule that reflects activities and/or events that the first user has undertaken or will undertake.

At step 306, the itinerary server 102 determines an adjustment to be made to the itinerary based on the warning signal. The adjustment can include (i) removing a second event from the itinerary, (ii) extending a duration of the second event, or (iii) swap the second event and a third event in the itinerary. The adjustment can include moving events to a next day as indicated in step 218 of FIG. 2. One or more scores can be used for swapping events. For example, “Attraction selection score” as defined in connection with Eqn. 3 for the third event can be recalculated to be higher than that of the second event based on the warning signal. The “Attraction selection score” can then form a basis for swapping the second event with the third event. In the example where the second event is determined to be swapped with the third event, “Reachability” may be a deciding factor based on the current location of the first user. That is, “Reachability” may cause the third event to be more attractive as the next event compared to the second event.

At step 308, once the specific adjustment to be taken has been optimized for the first user, the itinerary server 102 adjusts the itinerary according to the determined adjustment of step 306 such that the warning signal generated at step 304 is muted. In some implementations, the itinerary server 102 requests permission from the first user prior to implementing the adjustment. For example, the itinerary server 102 can provide the adjustment to the client device 104. The itinerary server 102 can then receive a feedback signal from the client device 104. The feedback signal can indicate that the adjustment be made to the itinerary. Once the feedback signal indicates such, then itinerary server 102 proceeds to changing the itinerary according to the adjustment.

In some implementations, the client device 104 provides a feedback signal that indicates that the determined adjustment not be made. The itinerary server 102 can then suggest a different action or adjustment to be taken.

In some implementations, the itinerary server 102 provides all possible adjustments to the client device 104 so that the client device 104 selects from a list of adjustments.

FIG. 4 illustrates a screenshot 400 of part of an itinerary generated for a user, according to some embodiments of the present disclosure. The screenshot 400 can be a screenshot displayed on the client device 104. The itinerary can include a title bar with a navigation button 402. The itinerary can include multiple days with activities of each day being displayed in a selection-menu format. For example, Day 1 402a is selected and Day 2 402b and Day 3 402c are not selected. Hence, Day 2 402b and Day 3 402c are displayed as being faded. In some implementations, the date for the different days are also displayed. For example Day 1 402a has a date 404a of Friday, 29 Mar. 2020, Day 2 402b has a date 404b of Saturday, 30 Mar. 2020, and Day 3 402c has a date 404c of Sunday, 31 Mar. 2020. In some implementations, a share button 406 is provided to allow a user of the client device 104 to share the itinerary with another person. In some implementations, a help button 408 is provided to allow the user to inquire on different aspects or features of the itinerary.

The screenshot 400 shows a first event 410 on the selected day Day 1 402a. The first event 410 is identified with a title 410a and a start time 410b. In some implementations, a representative photo or emblem 410c is displayed in the itinerary. In some implementations, the user has the option of displaying the first event 410 in a map using button 410d. In some implementations, the user has the option of acquiring more details about the first event 410 using button 410e. The first event 410 is an example of a hotel or lodging event where the title 410a is identified as “Check in” with a start time 410b at “11:00 am”. The emblem 410c identifies the name of the hotel.

The screenshot 400 shows a second event 414 after the first event 410, but between the second event 414 and the first event 410, there is a transit event 412. The transit event 412 is identified by a title 412a which says “Transit”. The transit event 412 includes a start time 412b which in this example is “12:00 pm”. In some implementations, the transit event 412 can further include estimated transit properties 412c. The estimated transit properties 412c of FIG. 4 include as examples, a mode of transportation (car symbol), a distance to be traveled (3.6 km), and the transit time (1 hr 15 mins). The distance to be traveled and transit time can be adjusted based on transit options 412d indicated. Examples that can be included under the transit options 412d can be changing the mode of transportation to public transport (e.g., a bus, a train), biking, a motorcycle taxi, a water taxi, walking, etc. These different modes of transportation will change the displayed distance to be traveled and the transit time because routes and travel speed may change based on the selected mode of transportation.

The screenshot 400 shows the second event 414 to have a title 414a and a start time 414b. The entirety of the second event 414 is not shown but the user can scroll down to see further details about the second event 414. The itinerary can further include a total 416 for the entire trip (including the different attractions in the itinerary). The itinerary can further include an overlay of a map button 418 that when pressed can display a map for the day showing the different locations for attractions, events, restaurants, etc., where the user will visit. Furthermore, the map can show routes that the user will use when transitioning from one event to another. The screenshot 400 further shows a continue button 420 that allows the user to move on to a next page for booking the trip. In some implementations, the continue button 420 can lead to a payment page where the user enters payment information once which will then be used by the itinerary server 102 to pay for all hotels, modes of transportation, secure tickets for attraction, or any combination thereof.

FIG. 5 illustrates an example graph 500 communicating crowd congestion at a location (e.g., at an attraction, restaurant, etc.) according to some embodiments of the present disclosure. The graph 500 indicates that on a selected day 502 (on a Wednesday), the location has more foot traffic around 1 PM to 3 PM compared to LOAM, 11 AM, 12 PM, 4 PM, and 5 PM. When fitting the location in an itinerary, the itinerary server 102 can determine that at a most congested time 506, premium tickets may be required. The itinerary server 102 can determine that the location best fits at non-congested times like LOAM, 11 AM, etc. The itinerary server 102 can determine that a slightly-congested time 504 may be more appropriate depending on the business. For example, a live band is more enjoyable with other audience members, as such the slightly-congested time 504 may be more appropriate so the user can find space to relax as opposed to the most congested time 506 where the user may not be able to find a best spot or vantage point to view the live performance. The itinerary server 102 can rely on the external system 106 to receive information such as those provided by the graph 500 as discussed above in connection with FIG. 1.

Some embodiments of the present disclosure use weights and weighted averages to determine scores used to select activities, hotels, flights, routes, etc. Machine learning and constraint programming can be used to determine the weights in some implementations. Taking Eqn. 3 as an example, Attraction Selection Score is dependent on Best time to visit, Reachability, and Minimum spend time. From the definition, the weights associated with each of the dependencies are w₁, w₂, and w₃, respectively. Furthermore, w₁ is greater than w₂ which is greater than w₃. As such, Best time to visit is weighted more heavily compared to Reachability, which is weighted more heavily compared to Minimum spend time. Best time to visit, Reachability, and Minimum spend time are independent of any user and are merely data collected about many different attractions, as such, user customization is dependent on the weight values w₁, w₂, and w₃. Given a sample list of attractions, Best time to visit, Reachability, and Minimum spend time can be determined for each attraction in the sample list. The sample list can be a curated list based on what types of attractions the user or members in the user's cohort have deemed appropriate. Using the constraints on w₁, w₂, and w₃, a regression technique can be used to determine the weight values w₁, w₂, and w₃ that fits the sample list. Regression techniques can calibrate according to data generated by the system 100 within various time spans. For example, in an initial run, the weight values for w₁, w₂, and w₃ may be set according to the relationship w₁>w₂>w₃. However, after regression, weight proportions over the various time spans can settle to a different relationship, e.g., w₁=w₂>w₃, etc. Learning and/or training as described herein can be performed to determine weights in other situations described herein in the present disclosure (e.g., for the other equations included in the present disclosure).

According to some embodiments of the present disclosure, processes described above with reference to flow charts or flow diagrams (e.g., in FIGS. 2-3) may be implemented in a computer software program. For example, some embodiments of the present disclosure include a computer program product, which includes a computer program that is carried in a computer readable medium. The computer program includes program codes for executing the method 200 and/or the method 300. The computer program may be downloaded and installed from a network (e.g., the Internet, a local network, etc.) and/or may be installed from a removable medium (e.g., a removable hard drive, a flash drive, an external drive, etc.). The computer program, when executed by a central processing unit implements the above functions defined by methods and flow diagrams provided herein in the present disclosure.

A computer readable medium according to the present disclosure may be a computer readable signal medium or a computer readable storage medium or any combination of the above two. Examples of the computer readable storage medium may include electric, magnetic, optical, electromagnetic, infrared, or semiconductor systems, elements, apparatuses, or a combination of any of the above. More specific examples of the computer readable storage medium include a portable computer disk, a hard disk, a random access memory (RAM), a read only memory (ROM), an erasable programmable read only memory (EPROM or flash memory), an optical fiber, a portable compact disk read only memory (CD-ROM), an optical memory, a magnetic memory, or any suitable combination of the above.

The computer readable storage medium according to some embodiments may be any tangible medium containing or storing programs, which may be used by, or used in combination with, a command execution system, apparatus or element. In some embodiments of the present disclosure, the computer readable signal medium may include a data signal in the base band or propagating as a part of a carrier wave, in which computer readable program codes are carried. The propagating data signal may take various forms, including but not limited to an electromagnetic signal, an optical signal, or any suitable combination of the above. The computer readable signal medium may also be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium, including but not limited to: wireless, wired, optical cable, RF medium, etc., or any suitable combination of the above.

A computer program code for executing operations in the present disclosure may be compiled using one or more programming languages or combinations thereof. The programming languages include object-oriented programming languages, such as Java or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or electronic device. In the circumstance involving a remote computer, the remote computer may be connected to a user's computer through any network, including local area network (LAN) or wide area network (WAN), or be connected to an external computer (for example, connected through the Internet using an Internet service provider).

The flow charts and block diagrams in the accompanying drawings illustrate architectures, functions and operations that may be implemented according to the systems, methods and computer program products of the various embodiments of the present disclosure. Each of the blocks in the flow charts or block diagrams may represent a program segment or code that includes one or more executable instructions for implementing specified logical functions. It should be further noted that, in some alternative implementations, the functions denoted by the flow charts and block diagrams may also occur in a sequence different from the sequences shown in the figures. For example, any two blocks presented in succession may be executed substantially in parallel, or sometimes be executed in a reverse sequence, depending on the functions involved. It should be further noted that each block in the block diagrams and/or flow charts as well as a combination of blocks in the block diagrams and/or flow charts may be implemented using a dedicated hardware-based system executing specified functions or operations, or by a combination of dedicated hardware and computer instructions.

Engines, handlers, generators, managers, or any other software block or hybrid hardware-software block identified in some embodiments of the present disclosure may be implemented by software, or may be implemented by hardware. The described blocks may also be provided in a processor, for example, described as: a processor including a recommendation engine, an application programming interface, a schedule managing engine, an inventory managing engine, a reservation and payments managing engine, a live rescheduling engine, a trip generator, a notifications engine, etc.

While the present disclosure has been described with reference to one or more particular implementations, those skilled in the art will recognize that many changes may be made thereto without departing from the spirit and scope of the present disclosure. Each of these embodiments and implementations and obvious variations thereof is contemplated as falling within the spirit and scope of the present disclosure, which is set forth in the claims that follow.

What is claimed is:

1. A system for dynamically updating travel itineraries, the system comprising a processor and a non-transitory computer readable medium storing instructions such that when the instructions are executed by the processor, the system is configured to:
determine, using a trip generator of the system, an itinerary based on inputs received from a client device associated with a first user, user profiles associated with other users, and a user profile associated with the first user, wherein the user profile associated with the first user includes prior travel habits of the first user and preferences of the first user;
generate, using a notification engine of the system, a warning signal based on status signals received from the client device, the warning signal indicating at least one of a cancellation of a first event in the itinerary or a delay of the first event in the itinerary;
determine, using a scheduling managing engine of the system, an adjustment to be made to the itinerary based on the warning signal, wherein the adjustment includes at least one of: removing a second event from the itinerary, extending a duration of the second event, or swap the second event and a third event in the itinerary;
provide, using the live rescheduling engine of the system, the adjustment to the client device;
receive, using an application programming interface of the system, a feedback signal from the client device, the feedback signal indicating that the adjustment be made to the itinerary; and
adjust, using the live rescheduling engine of the system, the itinerary according to the adjustment.

2. The system of claim 1, wherein the status signals include a GPS location of the first user, a GPS location of the first event, a travel time relating to the first event, a current time, a start time of the first event, an end time of the first event, a duration of the first event, or a mode of transportation relating to the first event.

3. The system of claim 1, wherein the first user and the other users are in a same cohort, wherein a cohort includes individuals in at least one of: a same gender, a same age group, a same geographical region, or similar interests.

4. The system of claim 3, wherein the first user and the other users being in the same cohort indicates that the first user and the other users have similar user correlation indexes.

5. The system of claim 4, wherein user correlation indexes are determined by a recommendation engine of the system using an unsupervised learning approach where users in the same cohort have the same user correlation index.

6. The system of claim 1, wherein the warning signal further indicates a change in preference of the first user.

7. The system of claim 1, wherein the warning signal further indicates an emergency ticket cancellation by a service provider, a calamity associated with the first event, or both.

8. The system of claim 1, wherein determining the itinerary includes optimizing, using the schedule managing engine of the system, commute time between places of interest selected for the itinerary.

9. The system of claim 1, wherein determining the itinerary includes optimizing for opening and closing hours of the places of interest using the schedule managing engine of the system.

10. The system of claim 1, wherein determining the itinerary includes determining, using the schedule managing engine of the system, best times to visit at least one of the places of interests based at least in part on the user profiles associated with other users and the user profile associated with the first user.

11. The system of claim 1, further configured to:
provide the client device with a prompt for payment use a reservation and payments managing engine of the system;
receive a single payment authorization from the client device using the API; and
secure, using the reservation and payments managing engine of the system, tickets for at least one of the places of interest with the single payment authorization.

12. A method for dynamically updating travel itineraries, comprising:
determining, by a server, an itinerary based on inputs received from a client device associated with a first user, user profiles associated with other users, and a user profile associated with the first user, wherein the user profile associated with the first user includes prior travel habits of the first user and preferences of the first user;
generating, by the server, a warning signal based on status signals received from the client device, the warning signal indicating at least one of a cancellation of a first event in the itinerary or a delay of the first event in the itinerary;
determining, by the server, an adjustment to be made to the itinerary based on the warning signal, wherein the adjustment includes at least one of: removing a second event from the itinerary, extending a duration of the second event, or swap the second event and a third event in the itinerary;
providing, by the server, the adjustment to the client device;
receiving, by the server, a feedback signal from the client device, the feedback signal indicating that the adjustment be made to the itinerary; and
adjusting, by the server, the itinerary according to the adjustment.

13. The method of claim 12, wherein the status signals include a GPS location of the first user, a GPS location of the first event, a travel time relating to the first event, a current time, a start time of the first event, an end time of the first event, a duration of the first event, a mode of transportation relating to the first event,

14. The method of claim 12, wherein the first user and the other users are in a same cohort, wherein a cohort includes individuals in at least one of: a same gender, a same age group, a same geographical region, or similar interests.

15. The method of claim 14, wherein the first user and the other users being in the same cohort indicates that the first user and the other users have similar user correlation indexes.

16. The method of claim 15, wherein user correlation indexes are determined using an unsupervised learning approach where users in the same cohort have the same user correlation index.

17. The method of claim 12, wherein the warning signal further indicates a change in preference of the first user.

18. The method of claim 12, wherein the warning signal further indicates an emergency ticket cancellation by a service provider, a calamity associated with the first event, or both.

19. The method of claim 12, wherein determining the itinerary includes optimizing commute time between places of interest selected for the itinerary.

20. A client device associated with a first user, the client device comprising a processor and a non-transitory computer readable medium storing instructions such that when the instructions are executed by the processor, the client device is configured to:
send inputs to a server;
receive, from a trip generator of the server via an application programming interface of the server, an itinerary based on the sent inputs, user profiles associated with other users, and a user profile associated with the first user, wherein the user profile associated with the first user includes prior travel habits of the first user and preferences of the first user;
send status signals to the server via the API of the server;
receive an adjustment from a live rescheduling engine of the server via the API, the adjustment including at least one of: removing a second event from the itinerary, extending a duration of the second event, or swap the second event and a third event in the itinerary,
wherein the adjustment was generated, by a scheduling managing engine of the system, based on the status signals indicating at least one of a cancellation of a first event in the itinerary or a delay of the first event in the itinerary;
send a feedback signal to the server via the API, the feedback signal indicating that the adjustment be made to the itinerary; and
receive, via the API, an adjusted itinerary from the server.
